(19) United States
(12) Patent Application Publication
(10) Pub. No.: US 2004/0055346 A1
(43) Pub. Date: Mar. 25, 2004

(54) Manipulationproof electromagnet arrangement, an electronic locking cylinder and a method for preventing manipulation of an electromagnet arrangment

(76) Inventor: Joachim Gillert, Koln (DE)

Correspondence Address: Henneman & Saunders, 714 W. Michigan Ave., Three Rivers, MI, 49093, US

(21) Appl. No.: 10/611,841

(22) Filed: Jul. 1, 2003

(30) Foreign Application Priority Data
Jul. 3, 2002 (DE) 102 30 344.4

(51) Int. Cl. E05B 47/00

(52) U.S. Cl. 70/276

(57) ABSTRACT

A manipulationproof electromagnet arrangement for operating a switching device, in particular a coupling in an electronic locking cylinder, having an electromagnet which has at least one coil and one armature which can be moved by means of the coil from a rest position in an axial direction to a switching position, with the electromagnet arrangement having magnetic security means which respond to an external magnetic field, which originates from a manipulation location outside the electromagnet arrangement, such that any movement of the armature to the switching position is constrained, wherein the magnetic security means are arranged in a region between that end of the armature which faces the switching position in the rest position, and the manipulation location.

### FOREIGN PRIORIY

This application claims the right of foreign priority to Application No. 102 30 344.4 filed in Germany on Jul. 3, 2002 by the same inventor, which is incorporated herein in its entirety.

### BACKGROUND OF THE INVENTION

The present invention relates to a manipulationproof electromagnet arrangement for operating a switching device, in particular a coupling in an electronic locking cylinder, having an electromagnet which has at least one coil and one armature which can be moved by means of the coil from a rest position in an axial direction to a switching position, with the electromagnet arrangement having magnetic security means which respond to an external magnetic field, which originates from a manipulation location outside the electromagnet arrangement, such that any movement of the armature to the switching position is constrained.

The present invention also relates to an electronic locking cylinder having a coupling for coupling a locking tab or a locking bit to a shaft, and having an electromagnet arrangement for operating the coupling.

Finally, the present invention relates to a method for preventing manipulation of an electromagnet arrangement which contains an electromagnet which has at least one coil and one armature which can be moved by means of the coil from a rest position in an axial direction to a switching position, with the electromagnet arrangement having magnetic security means which respond to an external magnetic field which originates from the manipulation location outside the electromagnet arrangement, such that any movement of the armature to the switching position is constrained.

A manipulationproof electromagnet arrangement, an associated method for manipulation protection and an electronic locking cylinder such as this are known from EP 0 999 328 A1.

Locking cylinders for installation in locks, in particular mortise dead locks, have been known for many years, in particular in the form of mechanical locking cylinders with pin tumblers.

Furthermore, what are referred to as electronic locking cylinders have been used for many years. In locking cylinders such as these, a coupling is produced between the locking bit and an operating device or handle (for example a knob or latch) after verification of an electronic access control code. This may be done, for example, via a card reader which is associated with the lock, or a key-operated switch, etc., or else without these wires, in general by radio or else inductively.

For identification without the use of wires what are referred to as transponders are frequently used as “keys” which may be in either an active or a passive form. Evaluation electronics which are associated with the lock then receive the unique code of the bearer of the electronic key and, provided that access authorization is given, then couples the locking bit to the operating apparatus (for example a knob or latch) such that they rotate together, so that the actual unlocking process can be carried out by hand, by rotating the knob/latch and hence the locking bit. The coupling is then opened again by means of suitable time control. In the open, state, operation of the operating device does not lead to the lock being unlocked.

Electromagnet arrangements are generally used for coupling the knob (latch) to the locking bit. These can be miniaturized to a sufficiently great extent, for example for installation in the housing of a standard profiled cylinder. The electromagnet arrangement may be designed to be either monostable or bistable, or may be in the form of a bi-directional magnet arrangement.

The electromagnet arrangement has a coil and an armature in an intrinsically conventional manner. The armature is generally soft-magnetic. Application of a voltage to the coil results in a magnetic field which magnetizes the soft-magnetic armature. The armature is then moved in the axial direction by magnetic forces. This may be done, for example, against spring force, in order, to achieve a stable rest position. The axial movement of the armature makes it possible to operate a switching device, in particular a coupling in an electronic locking cylinder.

Electronic locking cylinders of this type are superior to conventional mechanical locking cylinders from may points of view, in particular with regard to operability and variability (quickly changing access authorisations, setting up and changing time zones, remote control options, recording of locking processes and integration in locking systems).

However, unlocking reliability is sometimes problematic. Since the armature is soft-magnetic, it is generally feasible for a very strong magnetic field to be applied in order in this way to move the armature to the switching position even without activation of the coil.

It is admittedly possible to install electromagnets in such a way that an external magnetic field from the outside of the door cannot manipulate the electromagnet in the direction of the switching position. However, an external magnetic force from the inside will then successfully result in manipulative coupling. This is disadvantageous, particularly for cylinders which can be locked from both sides.

It is known from the initially cited EP 0 999 328 A1 for an opposing magnet to be provided on a central section of the armature. This opposing magnet can preferably be magnetized by an external magnet field, but must be isolated from the rest of the magnetic circuit via a magnetic decoupling device. Furthermore, a disk composed of ferromagnetic material is provided on the same armature section. In the event of any manipulation attempt by means of a strong external magnetic field, the opposing magnet is then intended to exert a stronger force on the ferromagnetic disk on the armature than a drive device, so that the armature is moved to the rest position. Mention is also made that the opposing magnet can be designed such that it activates a blocking device when an external magnetic field is applied for manipulation purposes. The blocking device is then designed such that it prevents engagement or closing of the coupling.

Against this background, the object of the present invention is to specify a manipulationproof electromagnet arrangement of simpler design, as well as an electronic locking cylinder equipped with this electromagnet arrangement, and an associated method.

### SUMMARY OF THE INVENTION

For the manipulationproof electromagnet arrangement mentioned initially, this object is achieved in that the magnetic security means are arranged in a region between that end of the armature which faces the switching position in the rest position, and the manipulation location.

This object is achieved for an electronic locking cylinder as mentioned initially by the locking cylinder containing such an electromagnet arrangement.

For the method according to the invention, this object is achieved in that the magnetic security means respond to an external magnetic field which originates from the manipulation location outside the magnet arrangement in a region between that end of the armature which faces the switching position in the rest position, and a manipulation location in such a way that any movement of the armature to the switching position is constrained.

The installation location of the magnetic security means ensures that the magnetic security means respond to the external magnetic field earlier and are more sensitive for this purpose, thus making it possible to ensure greater security than with the prior art. Furthermore, the installation location makes it possible to design the magnetic security means to be simpler and hence more cost-effective.

It is self-evident that the end of the armature relates to the soft-magnetic part of the armature. Thus, if a non-magnetic section projects at that end of the armature which faces the switching position in the rest position, then the magnetic security means can also be provided in the region of the projecting non-magnetic sections of the armature.

In the present context, the expression “constraining” should be understood as meaning that any movement of the armature to the switching position is generally completely prevented, but in any case is made considerably more difficult.

The above object is thus achieved completely.

According to a first preferred embodiment, the magnetic security means have a reed switch which is arranged between that end of the armature which faces the switching position and the manipulation location and is connected to a control means which prevents any movement of the armature to the switching position when the reed switch is subject to the external magnetic field.

This embodiment of magnetic security means is comparatively cost-effective, since reed relays or switches are advantageously available in widely differing forms. Furthermore, the circuitry for a reed switch is simple.

In this case, it is particularly preferable for the control means to prevent the movement of the armature when an external magnetic field is present, in that the coil is driven such that the electromagnet actively holds the armature in the rest position.

This can be achieved, for example, by using the control means to reverse the polarity of the coil and to drive it actively such that force which is exerted by the coil on the armature counteracts the external magnetic field.

Such polarity reversal can likewise be achieved comparatively easily in the control means. Since, when the armature is in the rest position, it is generally at least partially located within the coil, even a comparatively small coil current is sufficient to counteract a very strong external magnetic field, so that the armature does not move to the switching position.

Additionally or alternatively, it is also possible for this purpose for the control means to prevent the movement of the armature when an external magnetic field is present by using the control means to drive a bolt mechanism which acts transversely with respect to the axial direction and holds the armature in an interlocking manner in the rest position.

In this embodiment, any movement of the armature from the rest position can be prevented by means of an interlock. In consequence, the electromagnet arrangement cannot be manipulated even by extremely strong external fields.

In one alternative preferred embodiment, the magnetic security means have a passive moving soft-magnetic locking element, which is drawn by the external magnetic field from a nominal position, which does not influence the capability of the armature to move, into the path of the armature so that the armature is held in an interlocking manner in the rest position.

The basic idea of this embodiment is just as simple as it is convincing. The arrangement of the moving soft-magnetic blocking element in the region between the end of the armature and the manipulation location means that it is reliably possible to ensure that the soft-magnetic blocking element reacts more sensitively to the external magnetic field than the armature and, in consequence, is drawn to the blocking position first, before the armature could be moved from the rest position by means of the external field.

As soon as the blocking element is in the blocking position, it blocks the armature, so that the armature is held in an interlocking manner in the rest position.

Both in the case of the embodiment with reed switches and in the case of the embodiment with a soft-magnetic blocking element, it is self-evident that the important factor is that these security means in each case react more sensitively to the external magnetic field than the armature. It is thus feasible in both embodiments for them also to be arranged in regions of the electromagnet arrangement other than the region between that end of the armature which faces the switching position in the rest position and the manipulation location, provided that greater sensitivity is ensured.

In one particularly preferred embodiment, the soft-magnetic blocking element is held in the nominal position by the force of gravity.

In consequence, no further means are required to render the soft-magnetic blocking element inoperative when no external magnetic field is applied.

According to a further preferred embodiment, the soft-magnetic blocking element has an associated soft-magnetic antenna element, which is arranged fixed to the housing in a region between the external magnetic field and the soft-magnetic blocking element.

The soft-magnetic antenna element antenna element can “focus” the external magnetic field so as to ensure that the soft-magnetic blocking element is drawn to the blocking position. In other words, skillful arrangement of the soft-magnetic antenna element ensures that the external magnetic field can be used reliably to draw the soft-magnetic blocking element to the blocking position irrespective of the relative position of the external magnet transversely with respect to the axial direction.

In this case, it is particularly preferable for the antenna element to be a cover section of a housing of the electromagnet arrangement.

Since a cover section such as this may normally be present in any case, no further additional element is in consequence required to form the soft-magnetic antenna element. However, alternatively, the cover section may also be in the form of a separate element, which is associated with the housing.

According to one particularly preferred embodiment, the soft-magnetic blocking element is in the form of a ball.

This makes it possible to ensure that the soft-magnetic blocking element can be drawn from the nominal position to the blocking position with as little friction as possible. Although it is generally also feasible for the blocking element to have a polyhedron form, this generally results, however, in rather flat friction contact, so that greater friction must be expected.

It is also preferable for the space in which the blocking element is mounted such that it can move, to be formed by a housing section composed of paramagnetic or diamagnetic material.

This ensures that the soft-magnetic blocking element can move freely within the space without being influenced by the force of gravity, and remains uninfluenced by weak magnetic fields (for example the stray field from the electromagnet).

Furthermore, overall, it is preferable for the soft-magnetic blocking element to be mounted in an annular space in the nominal position.

The annular space is in this case preferably aligned concentrically about the axis of the electromagnet arrangement. The ball can thus be moved freely by the force of gravity in the annular space as a function of the respective rotational installation position. In fact, the annular space in this case offers a large number of possible nominal positions in which the blocking element does*not influence the capability of the armature to move, to be precise irrespective of the relative installation position of the electromagnet arrangement with respect to the earth's field of gravity.

In this case, it is particularly preferable for the soft-magnetic antenna element to be aligned with one inner wall of the paramagnetic or diamagnetic housing section. In consequence, despite the paramagnetic or diamagnetic housing section, the antenna element focuses the magnetic lines of force of the external field into the annular space, so that the soft-magnetic blocking element is drawn by the external field toward the soft-magnetic antenna element, and is thus moved to the blocking position. The flush alignment ensures that the blocking element does not need to overcome any steps or the like when moving to the blocking position. Alternatively, the antenna can also be recessed slightly with respect to the inner wall.

It is self-evident that just an annular sector space or merely a radial channel can also be provided instead of an annular space, with less variability of installation positions. The critical factor is that the soft-magnetic blocking element can be moved to the blocking position within this space from a nominal position in which the capability of the armature to move is not influenced, with the soft-magnetic blocking element “blocking” the armature in this blocking position.

It is self-evident that the features which have been mentioned above as well as those which are still to be explained in the following text can be used not only in the respectively stated combination but also in other combinations or on their own, without departing from the scope of the present invention.

Exemplary embodiments of the invention will be explained in more detail in the following description and are illustrated in the drawing.

### BRIEF DESCRIPTION OF THE DRAWINGS

FIG. 1 shows a schematic perspective view of an electronic locking cylinder;

FIG. 2 shows a schematic longitudinal sectional view through an electromagnet arrangement for the locking cylinder shown in FIG. 1;

FIG. 3 shows a schematic sectional view similar to FIG. 2, with a first embodiment of magnetic security means;

FIG. 4 shows a sectional view along the line IV-IV in FIG. 3; and

FIG. 5 shows a schematic sectional view similar to FIG. 2, with a second embodiment of magnetic security means.

### DESCRIPTION OF PREFERRED EMBODIMENTS OF THE INVENTION

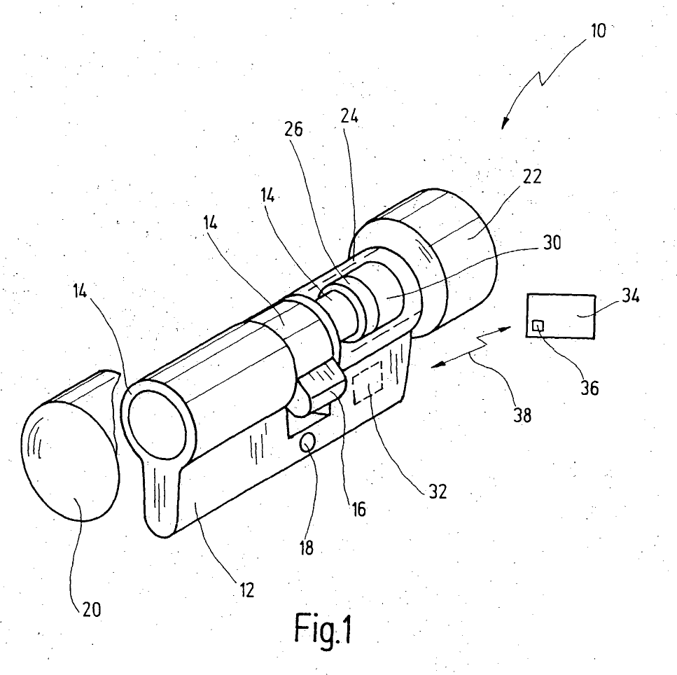

In FIG. 1, an electronic locking cylinder is annoted 10 overall.

The locking cylinder 10 has a housing 12, a profiled housing in the illustrated embodiment. A cylinder core 14 is mounted in the housing 12 such that it can rotate, with a locking bit 16, which is connected to the cylinder core 14 such that they rotate together, projecting approximately centrally out of an opening in the housing 12 in an intrinsically conventional manner. The cylinder core 14 may be either a solid component or else a hollow component.

18 denotes a conventional threaded hole for a striking plate screw.

A knob 20 on the inside of the door is connected to the cylinder core 14 such that they rotate together, so that unlocking movements of the locking bit 16 can be produced directly by means of the knob 20 on the inside of the door.

A latch or a similar operating element can also be provided instead of the knob 20.

A knob 22 (or latch) on the outside of the door is connected to a shaft 24 such that they rotate together, and the shaft 24 is mounted in the housing 12 such that it can rotate. The shaft 24 is in the form of a hollow shaft, and is aligned coaxially with the cylinder core 14.

The shaft 24 can be connected to the cylinder core 14 by means of a coupling 26, which is indicated schematically.

When the coupling 26 is open, the knob 22 on the outside of the door can be rotated freely without influencing the locking bit 16. When the coupling 26 is closed, rotation of the knob 22 on the outside of the door leads to rotation of the locking bit 16.

An electromagnet arrangement 30, which is likewise indicated schematically in FIG. 1, is provided in order to operate the coupling 26. The electromagnet arrangement 30 is connected to a control means 32. In the illustrated embodiment, the control means 32 are integrated in the profiled housing 12, but can also be arranged outside the profiled housing 12.

The control means 32 are used to check access authorization for somebody standing outside the door. If the person standing outside the door has access authorization, the control means 32 drive the electromagnet arrangement 30 such that the coupling 26 is closed. Otherwise, the electromagnet arrangement 30 is not driven.

In the illustrated embodiment, access authorization is provided without the use of wires by means of a transponder card 34, in which a transponder 36 is integrated.

The transponder 36 may be an active transponder which, on activation by the control means 32, sends an access authorization code to the control means 32, as is shown schematically at 38.

As an alternative to this, the transponder 36 may also be a passive transponder which has a coil arrangement which is activated by a read field of the control means 32, in order to induce a voltage which is used by a chip in the transponder 36 to read the identification code and to send it to the control means 32 via the same coil arrangement or via another coil arrangement.

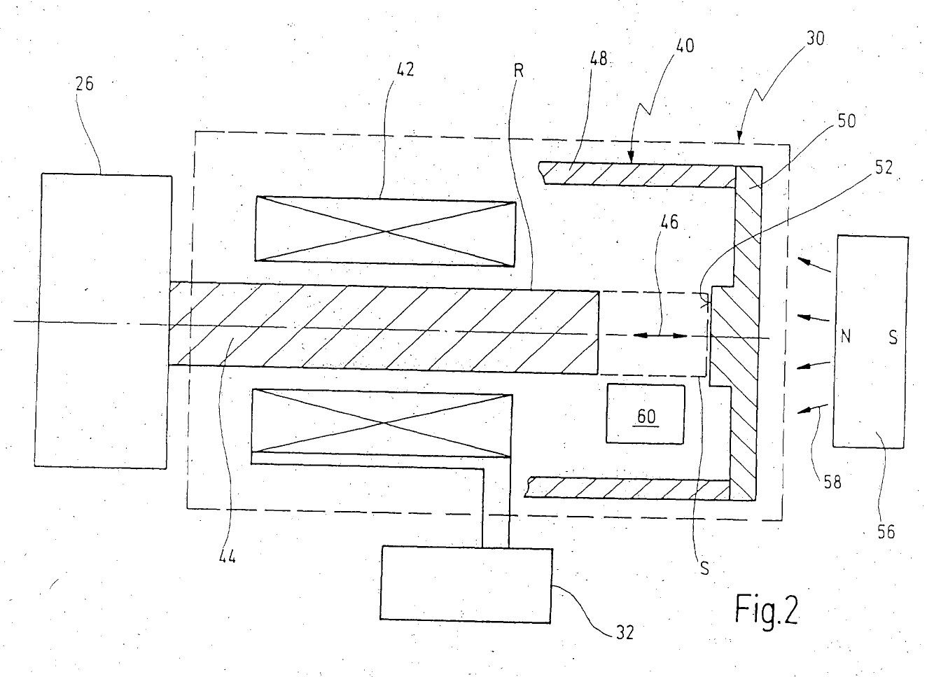

FIG. 2 shows a schematic sectional illustration of the electromagnet arrangement 30, in greater detail.

The electromagnet arrangement 30 has a housing 40 which, at least in part, can be formed by the housing 12 of the lock cylinder. However, it may also be a separate housing.

A coil 42 is mounted, fixed to the housing, in the housing 40. An armature 44 composed of a soft-iron material is mounted within the coil 42 such that it can move in the axial direction.

One end of the armature 44, which emerges from the electromagnet arrangement 30, is connected to the coupling 26. In the illustration in FIG. 2, the armature 44 is shown in a rest position R, in which the coupling 26 is open. Although this is not shown, the armature 44 can be prestressed to the rest position R by means of a spring.

Application of an electrical voltage to the coil 42 allows the armature 44 to be moved from the rest position R as shown to a switching position S, illustrated by dashed lines, as is shown schematically at 46. When the armature 44 is in the switching position S, the coupling 26 is closed.

The housing 40 in the illustrated embodiment has a cylindrical section 48 and a cover section 50. The cover section 50 closes an open end of the cylindrical section 48 in the direction of the switching position S.

A projection which forms a stop 52 for the armature 44 in the switching position S is formed on the cover section 50, on the inside of the housing.

The electromagnet arrangement 30 may be monostable, as mentioned above, so that the armature 44 is generally prestressed to a stable position, for example by means of a mechanical spring. However, the arrangement 30 may also be bistable, so that, after reaching the switching position S, the armature 44 remains in this position even without any electrical power being supplied to the coil 42. It can then be returned to the rest position R by, for example, reversing the polarity of the coil 42. Alternatively it is also possible for the electromagnet arrangement 30 to operate bi-directionally so that the armature 44 can be moved back from the switching position S to the rest position R for example by passing current through a second coil, which is not illustrated.

An external magnet which is arranged outside the electromagnet arrangement 30 and which produces an external magnetic field 58 is shown at 56.

The external magnet may be a powerful permanent magnet or else a powerful electromagnet. The external magnet 56 is, for example, placed against the outside of the door in order to manipulate the electromagnet arrangement 30 by drawing the armature 44 to the switching position S even without any electrical voltage being applied to the coil 42, in order to close the coupling 26.

Magnetic security means 60 are provided in order to prevent the armature 44 from being drawn to the switching position S when the external magnetic field 58 is present. The magnetic security means 60 are arranged in a region between the soft-magnetic part of the armature 44 and the points at which the external magnet 56 can be applied, for manipulation purposes.

This installation position allows the magnetic security means 60 to respond more sensitively to the external magnetic field 58 and, by appropriate security measures, to ensure that the armature 44 is not drawn to the switching position S despite the presence of the external magnetic field 58.

The critical factor is that these are magnetic security means which respond to a magnetic field 58. A further critical factor is that the magnetic security means respond more sensitively to the external field 48 than the armature 44. Provided that these preconditions are satisfied, the magnetic security means 60 may also be arranged at some other location within the electromagnet arrangement 30, or within or alongside the locking cylinder 10. In the illustrated embodiment, the risk of manipulation exists exclusively from the outside of the door. This is because the door can be opened anyway, without any problems, from the inside of the door by means of the knob 20 which is rigidly connected to the locking bit 16.

In principle, it is possible to ensure by suitable alignment of the electromagnet arrangement 30 that an external magnetic field 58 cannot move the armature 44 from the rest position R to the switching position S but, in fact, that such an external magnetic field 58 draws the armature 44 even more strongly to the rest position R.

However, in theory, it is feasible for the external magnetic field 58 to magnetize the housing and/or a yoke of the electromagnet arrangement 30, thus resulting in the armature 44 being subjected to a force which moves to the switching position S. In this situation, the magnetic security means 60 can prevent any movement of the armature 44, since the magnetic security means are used to block any movement of the armature 44 by virtue of their arrangement and/or by virtue of their magnetic characteristics and/or their capability to move easily.

Furthermore, the magnetic security means are important for those electronic locking cylinders in which both the knob on the inside of the door and the knob on the outside of the door are generally decoupled from the locking bit 16. This relates to locking cylinders in which the door cannot be opened either from the inside or from the outside until an access authorization check has been carried out.

In this situation, at least when the electromagnet arrangement 30 is in the axial installation position, a problem occurs in that an external magnetic field 58 from one side (for example from the outside of the door) draws the armature 44 to the rest position, but from the other side (for example from the inside of the door) draws it to the switching position. In this situation, the magnetic security means 60 would in any case be arranged on the side where there is a risk of manipulation, but in theory these means can also be arranged on both sides.

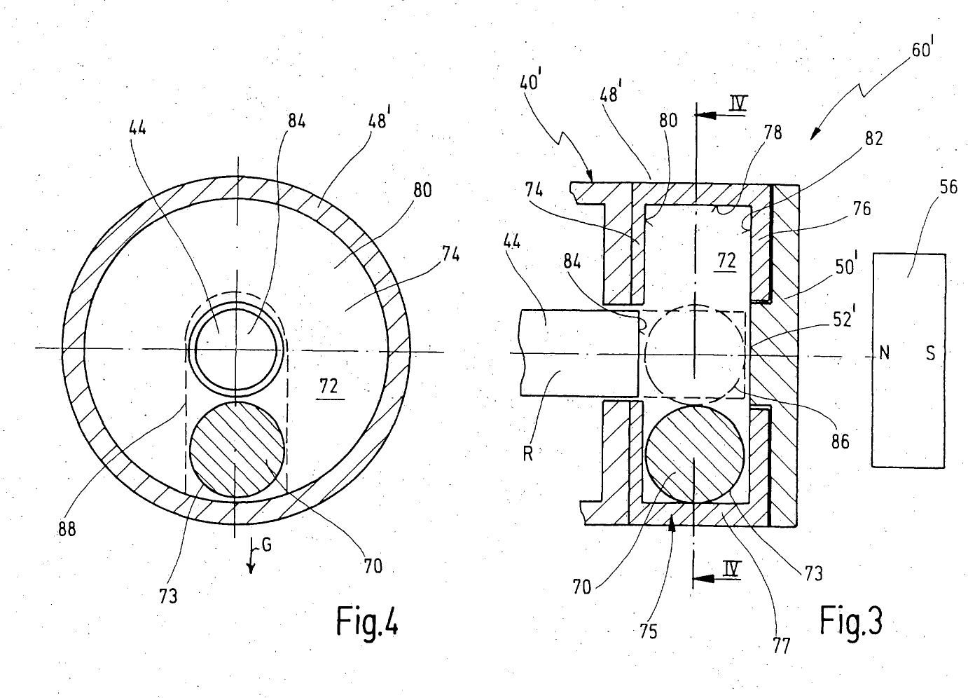

FIGS. 3 and 4 show a first embodiment of magnetic security means 60′.

The magnetic security means 60′ use a soft-magnetic blocking element 70 to block the movement of the armature 44 from the rest position R to the switching position S when an external magnetic field 58 is present.

The soft-magnetic blocking element 70 is normally mounted in an annular space 72 which is aligned concentrically with the axis of the electromagnet arrangement. The sectional illustration in FIG. 3 shows one of a theoretically infinite number of nominal positions 73 in which the soft-magnetic blocking element 70 is located when no external magnetic field 58 is applied. In the nominal position 73, the soft-magnetic blocking element 70 does not prevent the armature 44 from moving.

As is shown in FIG. 4, the soft-magnetic blocking element 70 is located in the lower region of the annular space 72, owing to the gravitational forces G. The annular space 72 ensures that the soft-magnetic blocking element 70 is not located in the path of the armature 44, irrespective of the rotational installation position of the electromagnet arrangement 30.

The annular space 72 is formed by an integral or multipart ring element 75, which has two radial projections 74 and 76 which originate from the inner circumference 78 of a cylindrical section 77 of the ring element 75. The radial projections 74, 76 are spaced apart from one another in the axial direction such that the soft-magnetic, blocking element 70 is mounted with play between them in the axial direction.

To be more precise, the annular space 72 is defined by the inner face 80 of the radial projection 74, by the opposite inner face 82 of the radial projection 76, and by the inner face 78 of the cylindrical section 48′.

The radial projection 74 extends sufficiently in the radial direction to allow the armature 44 to pass through it in the axial direction. Where the armature 44 is in the rest position R, the end face 84 of the armature 44 is aligned with the inner face 80.

The radial projection 76 extends over a similar distance in the radial direction, so that an opening remains into the annular space 72, in an axial plan view.

This opening is closed by the cover section 50, whose projection extends in the opening. The end face of the projection, which may form the stop 52′ for the armature 44, is then flush with, or is aligned slightly recessed from, the inner face 82 of the radial projection 76.

When the armature 44 is located in the rest position R, the soft-magnetic blocking element 70 can in consequence move throughout the entire space which contains the annular space 72 as well as that space which the armature 44 assumes in the switching position S.

The cylindrical section 77 including the radial projections 74, 76 is produced from a paramagnetic or diamagnetic material. On the one hand, this means that the blocking element 70 is isolated from the stray field from the coil 42 while, on the other hand, the walls of the annular space cannot be magnetized by the influence of an external field 58. Gravitation G always results in the soft-magnetic blocking element 70 being in one of the nominal positions 73 in this case.

In contrast, the cover section 50′ is produced from a soft-magnetic material.

When an external magnetic field 58 is present, the cover section 50 is magnetized, and the lines of force are concentrated on the projection of the cover section 50, which extends toward the annular space 72. Normally, the external magnetic field could also attract the armature 44, and move it to the blocking position. However, owing to the external magnetic field 58, the soft-magnetic blocking element 70 is drawn toward the projection on the cover section 50, so that it blocks the movement of the armature 44. This blocking position is illustrated by dashed lines at 86 in FIG. 3.

Owning to the shape of the ball, the soft-magnetic blocking element 70 can move within the annular space 72 with little friction. Since the inner face 82 is aligned flush with the stop 52′, the soft-magnetic blocking element 70 is moved easily, without any obstructions, into the blocking position 86.

As an alternative to the spherical shape, it is also feasible for the soft-magnetic blocking element to be in the form of a polyhedron, in particular of a cuboid or cube. It is also feasible for only one annular sector space to be provided instead of an annular space 72. This somewhat restricts the variability in terms of the installation position. However, this problem can be overcome by suitable assembly instructions. In the extreme, just one radial channel could be provided instead of an annular space for the soft-magnetic blocking element 70, as is indicated schematically at 88 in FIG. 4.

The soft-magnetic blocking element 70 need not necessarily be integral or all be composed of the same soft-magnetic material. For example, it is thus also possible to arrange a soft-magnetic casing around a light plastic element, in particular a hollow plastic element. It is also feasible to coat the outer circumference of the soft-magnetic blocking element 70 with a thin layer of another material in order to reduce friction.

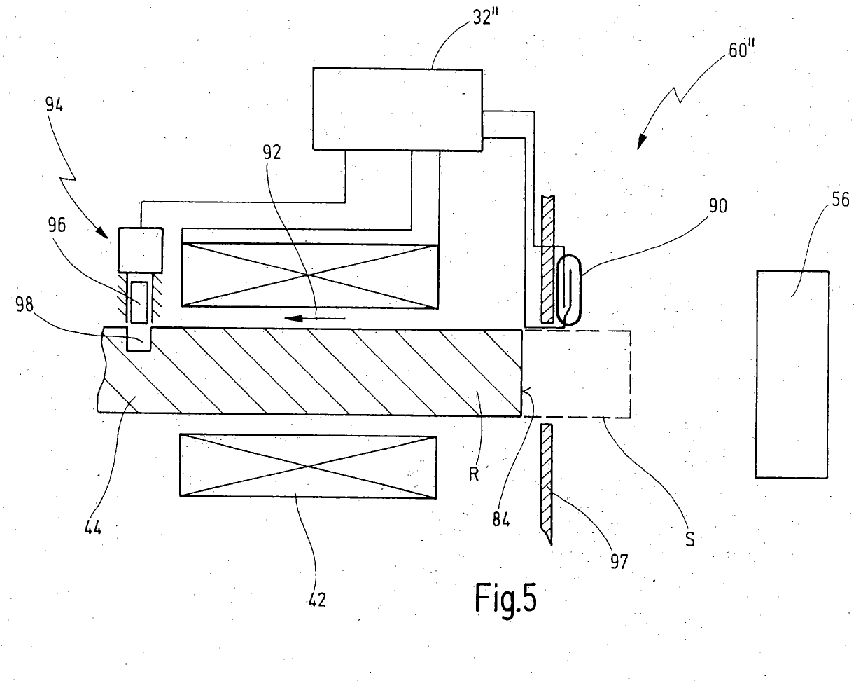

FIG. 5 shows a further embodiment of magnetic security means 60″.

In this embodiment, a reed switch 90 is arranged in the region between the armature 44 and the point at which the external magnet 56 acts. The reed switch 90 is arranged such that it switches immediately when an external magnetic field 58 occurs. The reed switch 90 is electrically connected to the control means 32″, so that the switching of the reed switch 90 can be detected in the control means.

In order to prevent the armature 44 from being drawn from the rest position R to the blocking position S the invention provides for the control means 32″ to reverse the polarity of the coil 42 when the reed switch 90 switches (or, in the case of bi-directional magnets, to pass the current through the appropriate coil), so that the coil 42 exerts a force on the armature 44 in the direction of the rest position R, as is shown schematically at 92 in FIG. 5. In consequence, the coil 42 is in this way driven actively in order to counteract the external magnetic field 58 and in order to prevent the armature 44 from being drawn to the switching position S.

A shielding element 97 is illustrated schematically at 97, which is produced from a paramagnetic or diamagnetic material and, together with the reed switch 90, is isolated from any stray field from the coil 42.

Alternatively or in addition to this, it is also possible for the control means 32″ to drive a bolt mechanism 94 when it detects that the reed switch 90 has switched, with the bolt mechanism 94 locking the armature 44 in an interlocking manner in the rest position R.

FIG. 5, shows schematically, a bolt 96 of the bolt mechanism 94, which is designed to engage in a corresponding radial blocking depression 98 in the armature 44. Alternatively, a bolt mechanism could also engage in the space between the armature 44 and the stop 50.

In consequence, the magnetic security means 60″ also reliably prevent the armature 44 from being drawn from the rest position R to the switching position S by means of a manipulative external field 58.

Although the illustrated embodiment shows a double cylinder, it is self-evident that the invention may also be implemented in half cylinders.

What is claimed is:

1. A manipulationproof electromagnet arrangement for operating a switching device, in particular a coupling in an electronic locking cylinder, having an electromagnet which has at least one coil and one armature which can be moved by means of the coil from a rest position in an axial direction to a switching position, with the electromagnet arrangement having magnetic security means which respond to an external magnetic field, which originates from a manipulation location outside the electromagnet arrangement, such that any movement of the armature to the switching position is constrained, wherein the magnetic security means are arranged in a region between that end of the armature which faces the switching position in the rest position, and the manipulation location.

2. The electromagnet arrangement of claim 1, wherein the magnetic security means have a reed switch which is arranged between that end of the armature which faces the switching position and the manipulation location and is connected to a control means which prevent any movement of the armature to the switching position when the reed switch is subject to the external magnetic field.

3. The electromagnet arrangement of claim 2, wherein the control means prevent the movement of the armature when an external magnetic field is present, in that the coil is driven such that the electromagnet actively holds the armature in the rest position.

4. The electromagnet arrangement of claim 2, wherein the control means prevent the movement of the armature when an external magnetic field is present in that the control means drive a bolt mechanism which acts transversely with respect to the axial direction and holds the armature in an interlocking manner in the rest position.

5. The electromagnet arrangement of claim 1, wherein the magnetic security means have a passive moving soft-magnetic locking element, which is drawn by the external magnetic field from a nominal position, which does not influence the capability of the armature to move, into the path of the armature so that the armature is held in an interlocking manner in the rest position.

6. The electromagnet arrangement of claim 5, wherein the soft-magnetic locking element is held in the nominal position by the force of gravity.

7. The electromagnet arrangement of claim 5, wherein the soft-magnetic blocking element has an associated soft-magnetic antenna element which is arranged fixed to the housing in a region between the external magnetic field and the soft-magnetic blocking element.

8. The electromagnet arrangement of claim 7, in which the antenna element is a cover section of a housing of the electromagnet arrangement.

9. The electromagnet arrangement of claim 5, wherein the soft-magnetic blocking element is in the form of a ball.:

10. The electromagnet arrangement of claim 5, wherein the soft-magnetic blocking element is mounted such that it can move in a space which is formed by a housing section composed of paramagnetic or diamagnetic material.

11. The electromagnet arrangement of claim 5, wherein the soft-magnetic blocking element is mounted in an annular space in the nominal position.

12. The electromagnet arrangement of claim 5, wherein the soft-magnetic blocking element has an associated soft-magnetic antenna element which is arranged fixed to the housing in a region between the external magnetic field and the soft-magnetic blocking element, the soft-magnetic blocking element is mounted such that it can move in a space which is formed by a housing section composed of paramagnetic or diamagnetic material and wherein the soft-magnetic antenna element is aligned with an inner wall of the paramagnetic or diamagnetic housing section.

13. An electronic locking cylinder having a coupling for coupling a locking bit to a shaft, and having an electromagnet arrangement for operating the coupling, wherein the electromagnet arrangement is a manipulation proof electromagnet arrangement for operating said coupling, having an electromagnet, which has at least one coil and one armature which can be moved by means of the coil from a rest position in an axial direction to a switching position, with the electromagnet arrangement having magnetic security means which respond to an external magnetic field, which originates from a manipulation location outside the electromagnet arrangement, such that any movement of the armature to the switching position is constrained, wherein the magnetic security means are arranged in a region between that end of the armature which faces the switching position in the rest position, and the manipulation location.

14. A method for preventing manipulation of an electromagnet arrangement which contains an electromagnet which has at least one coil and one armature which can be moved by means of the coil from a rest position in an axial direction to a switching position, with the electromagnet arrangement having magnetic security means between that end of the armature which faces the switching position in the rest position and a manipulation location, which security means respond to an external, magnetic field which originates from the manipulation location outside the electromagnet arrangement, such that any movement of the armature to the switching position is constrained.
